(19) United States
(12) Patent Application Publication
(10) Pub. No.: US 2014/0326128 A1
(43) Pub. Date: Nov. 6, 2014

(54) FLOW RESTRICTOR AND GAS COMPRESSOR

(71) Applicants: Henrique Bruggmann Muhle, Joinville (BR); Dietmar Erich Bernhard Lilie, Joinville (BR)

(72) Inventors: Henrique Bruggmann Muhle, Joinville (BR); Dietmar Erich Bernhard Lilie, Joinville (BR)

(73) Assignee: WHIRLPOOL S.A., Sao Paulo, SP (BR)

(21) Appl. No.: 14/358,559

(22) PCT Filed: Nov. 14, 2012
(86) PCT No.: PCT/BR2012/000449

§ 371 Date: May 15, 2014

(30) Foreign Application Priority Data
Nov. 16, 2011 (BR) PI1105480-8

(51) Int. Cl. F16C 32/06; F16J 1/02; F04B 53/00

(52) U.S. Cl. CPC F16C 32/0622; F04B 53/008; F16C 32/0685; F16J 1/02
USPC 92/127; 92/162 R

(57) ABSTRACT

A flow restrictor (1) for use in bearing formation between a piston (2) and a cylinder (3) of a gas compressor (4). The gas compressor (4) includes a protective pad (5) that externally surrounds the cylinder (3), and an inner cavity (6) is disposed between the protective pad (5) and the cylinder (3), fluidly fed by a discharge flow from a compression movement exerted by the piston (2). The gas compressor (4) further includes a bearing formation gap (7) that separates an outer wall of the piston (2) and an inner wall of the cylinder (3). A flow restrictor (1) is provided with a housing (12) that fluidly associates the inner cavity (6) to the bearing formation gap (7). The flow restrictor (1) includes a limiting tube (8) associated with the housing (12), provided with at least one restraining portion provided with a cross section sized to limit the gas flow from the inner cavity (6) to the bearing formation gap (7).

The present invention relates to a restrictor element configured to provide a limitation and/or control in the gas flow used in the bearing formation between a piston and a cylinder of a gas compressor.

The present invention also relates to a gas compressor comprising at least one restrictor element as above.

### DESCRIPTION OF THE STATE OF THE ART

Currently, it is quite common to use piston (plunger sets) and cylinders driven by electric motors for use in gas compressors and refrigeration equipment, such as domestic/commercial/industrial refrigerators, freezer and air conditioners.

In these types of compressors, the electric motor drives the piston which, in turn, moves within the cylinder in an axial reciprocating motion so as to compress the gas. Normally, in this cylinder head vales are positioned suction and gas discharge valves which regulate, respectively, the low pressure gas inlet and the high pressure gas outlet inside the cylinder. Thus, the axial movement of the piston within the cylinder of the compressor performs compression of the gas admitted by the suction valve, increasing its pressure in order to afford direction of gas flow through the discharge vale for a high pressure region.

One of the technical challenges noted in this type of gas compressor is avoiding direct contact between the piston and the cylinder. Thus, due to the relative motion between the piston and the cylinder, the bearing formation of the piston by means of a fluid disposed in the gap between these two parts to prevent their premature wear is necessary. The presence of the fluid between the piston and the cylinder also afford the reduction of friction between them, which allows a reduction of mechanical loss of the compressor.

The linear compressors frequently use a type of bearing formation, known as aerostatic bearing formation, which consists of implementing a gas cushion between the piston and the cylinder, avoiding contact between them. The use of aerostatic bearing formation is advantageous with respect to the other types of bearing formation, since, considering that the gas has a coefficient of viscous friction lower than the oil, the energy dissipated for the bearing formation is smaller, which contributes to a better compressor efficiency. Another additional advantage of using the gas itself as lubricant consists of the absence of the need to use an oil pumping system.

It should be noted that the gas used for the bearing formation may consist of a portion of the very gas pumped by the compressor and used in the refrigeration system, which is diverted, after its compression, towards the gap between the piston and the cylinder, forming a gas cushion that avoids contact between them. In this way, it is observed that all the gas used in the bearing formation represents a loss of efficiency of the compressor, since the main function of the compressed gas is its direct application in the refrigeration system to generate cold. Thus, the portion of the gas volume diverted to the bearing formation should be kept to a minimum so as not to significantly compromise the efficiency of the compressor.

Typically, in order to obtain an efficient operation of the aerostatic bearing, it is necessary to use a flow restrictor capable of limiting the flow of the compressed gas arising from a high pressure region of the compressor, so that the gas pressure present in the gap between the piston and cylinder is smaller and suitable for the application. In other words, such a constraint aims at allowing pressure reduction or control at the bearing formation region by restricting the flow of compressed gas arising from a high pressure region of the compressor.

Various constructive configurations have been developed to allow implementation of restrictors in order to afford the pressure reduction in the bearing formation region.

For example, the U.S. patent application US20040154468 describes a restrictor which comprises a porous medium, where a porous strip is used together with compression rings. A disadvantage of this type of configuration is the need for precision in the manufacture of the compression rings, which increases the cost of the production process, besides the difficulty of dimensional control.

The U.S. Pat. No. 6,293,684 discloses restrictors formed by micro channels disposed along the outer wall of the cylinder which, together with a sleeve in which said cylinder is inserted, form closed and isolated channels, yielding a plurality of restrictors. Analogous to the patent previously mentioned, a disadvantage of this type of configuration is the need for precision in the manufacture of sleeves, which increases manufacturing costs.

The international application WO/2008/055809 describes restrictors consisting of micro bores arranged in the cylinder wall, manufactured with the use of laser. Again, the manufacturing of the micro bores requires a lot of precision, which might impair the production of the compressor at competitive marker costs.

Thus, a satisfactory and efficient solution which presents good reliability and performance and whose cost is low is still not known for providing restriction in the gas flow used in the bearing formation between a piston and a cylinder of a gas compressor.

### OBJECTS OF THE INVENTION

A first object of the present invention consists of providing a low cost flow restrictor configured to allow a limitation and/or flow/gas pressure control used in the bearing formation between a piston and a cylinder of a gas compressor, reducing or avoiding loss of efficiency of said gas compressor, so as to obtain optimum performance and execution.

A second object of the present invention consists of providing a flow restrictor capable of allowing the diversion of at least one portion of compressed gas flow through a gas compressor for a bearing formation region between its piston and cylinder, without significantly compromising the efficiency of said gas compressor.

A third object of the present invention consists of providing a flow restrictor capable of allowing a limiting of the gas flow used in the bearing formation between a piston and a cylinder of a gas compressor.

A fourth object of the present invention consists of providing a gas compressor that comprises a flow restrictor according any one of the objects above or a combination thereof.

### BRIEF DESCRIPTION OF THE INVENTION

A first manner of achieving the first, second and/or third object of the present invention is through the provision of a flow restrictor for use in bearing formation between a piston and a cylinder of a gas compressor. Such a gas compressor comprises at least a protective pad which externally surrounds the cylinder. In addition, the gas compressor further comprises at least one inner cavity, disposed between the protective pad and the cylinder, fluidly fed by a discharge flow from a compression movement exerted by the piston within the cylinder. Additionally, the gas compressor further comprises at least one bearing formation gap separating an outer wall of the piston and an inner wall of the cylinder. Further, the gas compressor also comprises at least one flow restrictor provided with a housing fluidly linking the inner cavity to the bearing formation gap. Such a flow restrictor comprises at least a limiting tube, associated with the housing, provided with at least one restraining portion having a cross section sized to restrict the gas flow flowing from the inner cavity to the bearing formation gap.

A second way to achieve the first, second and/or third object of the present invention is through the provision of a flow restrictor for use in bearing formation between a piston and a cylinder of a gas compressor. Such a gas compressor comprises at least one protective pad which externally surrounds the cylinder. In addition, the gas compressor further comprises at least one inner cavity, disposed between the protective pad and the cylinder, fluidly fed by a discharge flow from a compression movement exerted by the piston within the cylinder. Additionally, the gas compressor further comprises at least one bearing formation gap separating an outer wall of the piston and an inner wall of the cylinder. Additionally, the gas compressor further comprises at least one flow restrictor provided with a housing that fluidly associates the inner cavity to the bearing formation gap. Such a flow restrictor comprises at least a limiting tube, associated with housing, having at least one restraining portion provided with a cross section having a pre-established area. Said limiting tube has a pre-established length, where the relationship between the cross section area of the restraining portion and the length of the limiting tube is configured to optimally limit the gas flow flowing from the inner cavity to the bearing formation gap.

The fourth object of the present invention is achieved through the provision of a gas compressor comprising a cylinder, a piston reciprocally movable within the cylinder and a flow restrictor according to first or second manners described above.

### BRIEF DESCRIPTION OF THE DRAWINGS

The present invention will be described below in greater detail, with reference to the attached drawings:

FIG. 1—depicts a side sectional view of a gas compressor, object of the present invention, which comprises a first preferred embodiment of a flow restrictor, also object of the present invention, when its suction valve is in the open condition;

FIG. 2—depicts a side sectional view of the gas compressor shown in FIG. 1, when its suction valve is in the closed condition;

FIG. 3—depicts a first detail of FIG. 2;

FIG. 4—depicts a second detail of FIG. 2;

FIG. 5A—depicts a side sectional view of a first preferred embodiment of the flow restrictor of the present invention;

FIG. 5B—depicts a side sectional view of a second preferred embodiment of the flow restrictor of the present invention;

FIG. 5C—depicts a side sectional view of a third preferred embodiment of the flow restrictor of the present invention;

FIG. 5D—depicts a side sectional view of a fourth preferred embodiment of the flow restrictor of the present invention;

FIG. 6—depicts a front sectional view of a fifth preferred embodiment of the flow restrictor of the present invention; and

FIG. 7A—depicts a side sectional view of a sixth preferred embodiment of the flow restrictor of the present invention;

FIG. 7B—depicts a side sectional view of a seventh preferred embodiment of the flow restrictor of the present invention;

FIG. 7C—depicts a side sectional view of an eighth preferred embodiment of the flow restrictor of the present invention;

FIG. 7D—depicts a side sectional view of a ninth preferred embodiment of the flow restrictor of the present invention; and

FIG. 7E—depicts a side sectional view of a tenth preferred embodiment of the flow restrictor of the present invention.

### DETAILED DESCRIPTION OF THE FIGURES

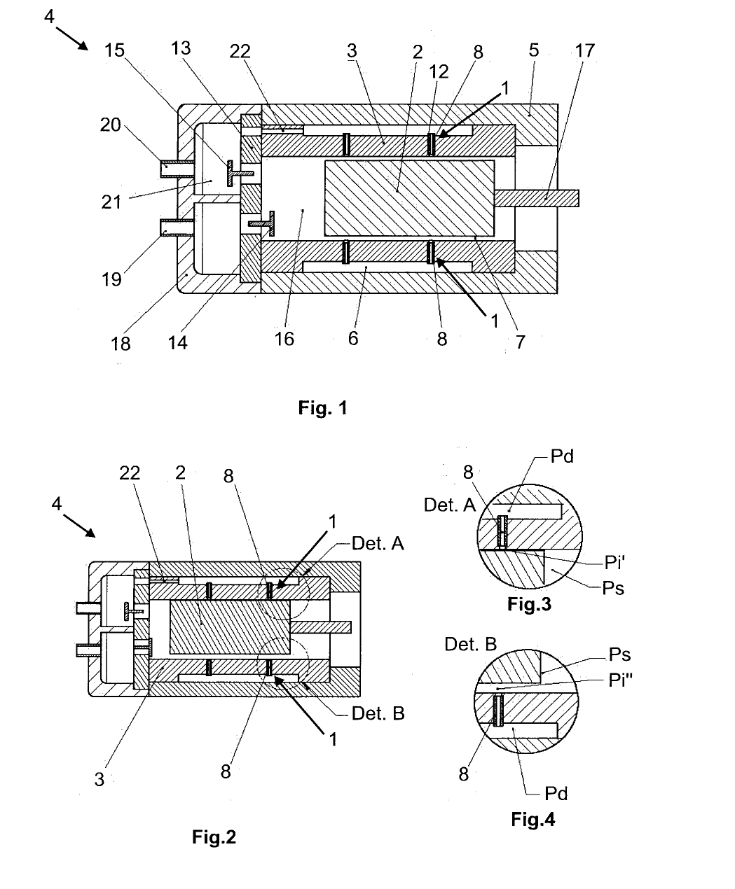

FIG. 1 illustrates a gas compressor 4 of the linear type according to a preferred embodiment of the present invention.

Such a gas compressor 4 comprises at least a piston 2, a cylinder 3 and a cylinder head 13 on its top or upper portion, forming, together with the piston 2 and the cylinder 3, a compression chamber 16, in that the axial and oscillating movement of piston 2 within the cylinder 3 affords the gas compression in the compression chamber 16.

As can be seen in FIG. 1, the gas compressor 4 is also provided with at least one suction valve 14 and a discharge valve 15, positioned in the cylinder head 13, which regulate the entry and exit of gas from the compression chamber 16. The gas compressor 4 is also provided with an actuator 17, associated with a linear motor, capable of actuating the piston 2.

In other words, piston 2, driven by said linear motor, has the function to develop an alternative linear movement, enabling the movement of piston 2 within the cylinder 3, so as to afford an action of compressing the gas admitted by the suction valve 14, up to the point at which it may be discharged to the high pressure side through the discharge valve 15.

Gas compressor 4 is also provided with a discharge passageway 20 and a suction passageway 19, positioned in a cap 18, which connect gas compressor 4 with the other portions, parts and components of a refrigeration system.

In addition, gas compressor 4 also comprises at least one protective pad 5 that externally surrounds the cylinder 3.

Additionally, gas compressor 4 comprises at least one inner cavity 6, disposed between protective pad 5 and cylinder 3, fluidly fed by a discharge flow from the compression movement exerted by piston 2 within cylinder 3. Inner cavity 6 is formed by the outer diameter of cylinder 3 and the inner diameter of protective pad 5.

Further, gas compressor 4 comprises at least one bearing formation gap 7 that separates an outer wall of piston 2 and an inner wall of cylinder 3, as seen in FIG. 1. The gas used for the bearing formation preferably consists on the gas itself pumped through gas compressor 4 and used in the refrigeration system. This compressed gas is diverted from a discharge camera 21 to inner cavity 6 through a connecting channel 22.

Gas compressor 4 comprises at least one flow restrictor 1, also object of the present invention, provided with a housing 12 that fluidly associates inner cavity 6 to bearing formation gap 7. The format of housing 12 may be substantially cylindrical or substantially conical.

As mentioned above, the function of the flow restrictor 1 is providing the bearing formation between piston 2 and cylinder 3 of gas compressor 4. In other words, flow restrictor 1, disposed between inner cavity 6 (high pressure region) and bearing formation gap 7, is capable of controlling the pressure in the bearing formation region and restricting gas flow.

From FIGS. 2, 3 and 4, the operation of the aerostatic bearing of the present invention may be understood. Inner cavity 6, connected to discharge camera 21 through connecting channel 22, presents gas with a discharge pressure Pd, which feeds flow restrictors 1. This gas, when passing through flow restrictors 1, loses pressure, forming a gas cushion of intermediate pressure Pi in bearing formation gap 7. This is the pressure that supports piston 2 and prevents it from touching the inner wall of cylinder 3. Finally, the gas flows out of the bearing formation gap 7, reaching a low pressure corresponding to suction pressure Ps of gas compressor 4.

When piston 2 suffers some axial force so as to approach cylinder wall 3, and consequently flow restrictor 1, bearing formation gap 7 in this region shrinks. (FIG. 3: detail A). The shrinking of bearing formation gap 7 causes an increase in load loss of the gas flow in regions in which it flows between piston 2 and cylinder 3. This increase in load loss causes a decrease in flow gas flow passing through flow restrictor 1 and bearing formation gap 7 in the region adjacent to flow restrictor 1. The decrease of flow implies a decrease in the flow speed of gas which, in turn, causes a decrease of load loss in flow restrictor 1. This reduction in load loss of the gas flow passing through flow restrictor 1 enables gas arriving to bearing formation gap 7 in the region of flow restrictor 1 to reach a pressure Pi′, greater than intermediate pressure Pi. This pressure increase acts to prevent piston 2 from further approaching cylinder wall 3 in the region of the flow restrictor 1, avoiding contact between piston 2 and cylinder 3.

On the other hand, in the opposite region of bearing formation gap 7 (FIG. 4: detail B), piston 2 moves away from cylinder wall 3 and flow restrictor 1. The increase in bearing formation gap 7 leads to a decrease in load loss of the gas flow in the gap region, increasing the gas flow passing through the gap and flow restrictor 1. The increase in the speed of gas flow increases the load loss of the flow on restrictor 1, which causes the gas to reach the bearing formation gap 7 in the region of the flow restrictor 1 with a pressure Pi″ lower than intermediate pressure Pi. This decrease of the intermediate pressure in the region of the flow restrictor 1 acts to reestablish the force balance of the bearing, preventing contact of piston 2 against the wall on the opposite region of cylinder 3.

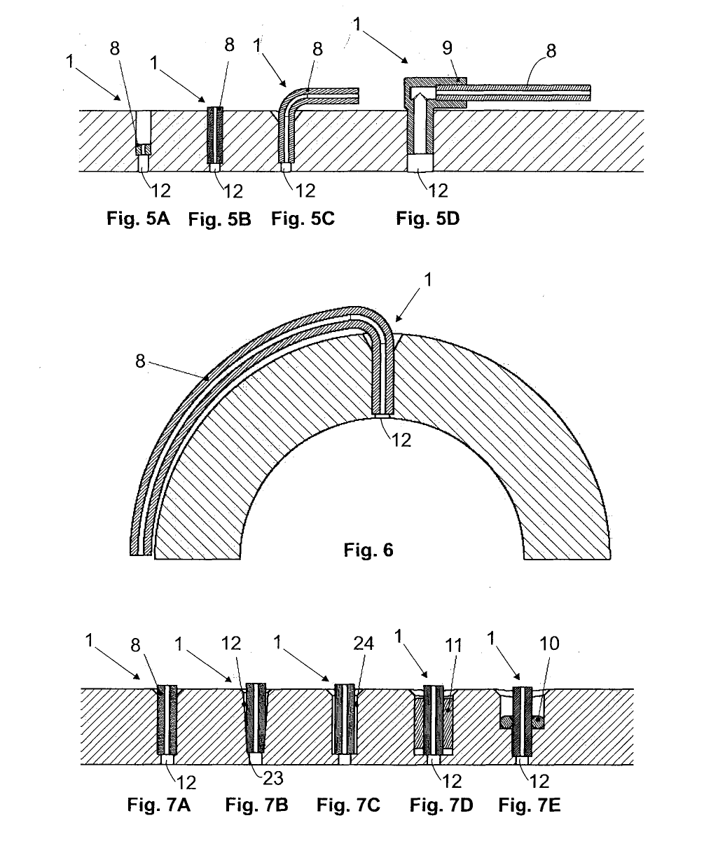

Flow restrictor 1 comprises at least one limiting tube 8 (or micro tube), associated with housing 12, provided with at least one restraining portion having a cross section sized to limit the gas flow that flows from inner cavity 6 to the bearing formation gap 7. Preferably, the restraining portion is positioned within housing 12. Thus, the gas flows through limiting tube 8 (or micro tube) towards the bearing formation gap 7, forming a gas cushion avoiding contact between piston 2 and cylinder 3. As can be seen in the preferred embodiments illustrated in FIG. 5C (third preferred embodiment), 6 (sixth preferred embodiment), 7A (seventh preferred embodiment) and 7E (tenth preferred embodiment), housing 12 may have a chamfered end facing inner cavity 6, which facilitates the insertion of limiting tube 8.

It should be noted that all of the gas used in bearing formation represents a loss of efficiency of the compressor, since the primary function of the gas is to be sent to the refrigeration system and provide temperature reduction. Thus, the gas diverted to the bearing formation should be kept at a minimum so as not to compromise the efficiency of the compressor. Therefore, the cross section of the restraining portion of limiting tube 8 has been designed to have a pre-established area and, moreover, limiting tube 8 has been designed to have a pre-established length, wherein the ration between the cross section area of the restraining portion and the length of limiting tube 8 is configured to limit gas flow that optimally flows from inner cavity 6 to bearing formation gap 7. Preferably, the substantially circular cross section has an inner diameter between 30 and 200 μm. The length of limiting tube 8 may vary in accordance with the preferred embodiment being implemented, as can be seen in FIGS. 5A, 5B, 5C, 5D and 6.

In other words, considering that the load loss imposed on the gas flow passing through limiting tube 8 is proportional to the length and diameter of its bore, it is possible to size said tube by varying these two measurements. For a given length, the greater the cross-sectional area to gas flow (i.e. the greater the inner diameter), the smaller the restriction imposed upon the flow. For a given inner diameter, the greater the length, the greater the restriction to gas flow. From these two variables—cross-sectional area to flow and length—it is possible to achieve the required load loss to any bearing of gas compressor 4.

For example, considering that piston 2 suffers with loss of support when it is in its top dead center due to the high pressure present at compression chamber 16, it is desirable that the bearings of this region of cylinder 3 provide greater gas flow than the bearing present in the inner portion of cylinder 3. In this case, one can act upon one of the two variables above in order to achieve a greater flow in flow restrictors 1 mounted in the region nearest the suction valve 14 and discharge vale 15.

Limiting tubes 8 may consist, for example, in micro tubes used in the manufacture of hypodermic needles or micro tubes used as electrodes in the process of electrical discharge machining (EDM) by penetration. Moreover, limiting tubes 8 are preferably made of metal, such as stainless steel (hypodermic needles), brass or copper (EDM tools).

Limiting tube 8 may be associated with housing 12 by an interference fit. Preferably, limiting tube 8 is fastened to housing 12 by adhesive or soldering, capable of filling a space between limiting tube 8 and housing 12.

Preferably, at least three flow restrictors 1 in a given section of cylinder 3 and at least two sections of flow restrictors 1 in cylinder 3 are implemented in the gas compressor 4, in order to maintain the balance of piston 2 within cylinder 3. Moreover, flow restrictors 1 are positioned such that, even with the oscillating movement of piston 2, they are never uncovered, i.e. piston 2 does not leave the work area of flow restrictors 1.

Preferably, limiting tube 8 is substantially cylindrical and has a substantially circular cross section, since the manufacturing of housing 12 can be made by a simple and inexpensive process such as piercing and, in addition, the micro tubes manufactured industrially are generally cylindrical. Naturally, limiting tubes 8 may present other forms of cross section.

Still preferably (first, second, sixth, eighth, ninth and tenth preferred embodiments, illustrated in FIGS. 5A, 5B, 7A, 7C, 7D and 7E respectively), limiting tube 8 has a substantially I-shaped profile.

Alternatively, according to the third preferred embodiment of the present invention, limiting tube 8 has a substantially L-shaped profile, as illustrated in FIG. 5C.

In the fourth preferred embodiment of the present invention, shown in FIG. 5D, limiting tube 8 is associated with housing 12 by means of a connector 9 having a substantially L-shaped profile, where a first end of connector 9 is associated with housing 12, and, a second end of connector 9 is associated with limiting tube 8.

According to the fifth preferred embodiment of the present invention, limiting tube 8 extends radially from housing 12 and is tangent to an outer wall of cylinder 3, as shown in FIG. 6.

According to the seventh preferred embodiment of the present invention, limiting tube 8 comprises an end portion 23 configured in a substantially conical format, end portion 23 being insertible in housing 12, as can be seen in FIG. 7B. Such conical shape facilitates the insertion of flow restrictor 1, so as to facilitate the sealing.

According to an eighth embodiment of the present invention, illustrated in FIG. 7C, limiting tube 8 is inserted in a plastic part 24 or plastic encapsulation over limiting tube 8. Subsequently, this set (limiting tube 8+plastic part 24) is inserted in flow restrictor 1.

According to a ninth preferred embodiment of the present invention, illustrated in FIG. 7D, flow restrictor 1 comprises a sealing bush 11, disposed within housing 12, longitudinally surrounding limiting tube 8. Preferably, sealing bush 11 is substantially conical and made of rubber, plastic and thermo shrinking plastic. Sealing bush 11 is associated with cylinder 3 through gluing or interference insertion in housing 12.

According to the tenth preferred embodiment of the present invention, illustrated in FIG. 7E, flow restrictor 1 comprises a sealing ring 10 disposed within housing 12, sealing ring 10 radially surrounding at least one portion of limiting tube 8. Preferably, sealing ring 10 consists of an O-ring ring.

Thus, limiting tube 8 may have a length of the same magnitude of the wall thickness, as well as it may be shorter or longer, or even have a length smaller than the outer diameter, taken on a disc shape, according to the first embodiment of the flow restrictor 1 of the present invention, illustrated in FIG. 5A.

Therefore, the present invention provides several ways of fixing limiting tube 8, so as to ensure the sealing between the outer wall of said limiting tube 8 and the inner wall of housing 12, forcing the gas to pass through the bore of limiting tube 8 to suffer the pressure drop required for the operation of the aerostatic bearing. In other words, the present invention allows the gas not to pass through an occasional gap between limiting tube 8 and cylinder wall 3. In sum, the preferred embodiments illustrated in FIGS. 7A to 7E, described above, show different ways to ensure fixation and sealing of limiting tubes 8 in housing 12, wherein they may be performed by any one or any combination of the preferred embodiments presented above.

Having described examples of preferred embodiments, it should be understood that the scope of the present invention encompasses other possible variations, being limited solely by the content of the appended claims, where possible equivalents are included.

1. A flow restrictor (1) for use in bearing formation between a piston (2) and a cylinder (3) of a gas compressor (4), gas compressor (4) comprising at least:
a protective pad (5) that externally surrounds the cylinder (3);
an inner cavity (6) disposed between the protective pad (5) and the cylinder (3), an inner cavity (6) being fluidly fed by a discharge flow from a compression movement exerted by the piston (2) within the cylinder (3);
a bearing formation gap (7) that separates an outer wall of the piston (2) and an inner wall of the cylinder (3); and
a flow restrictor (1) provided with a housing (12) that fluidly associates inner cavity (6) to bearing formation gap (7),
flow restrictor (1) being characterized in that it comprises at least one limiting tube (8) associated with the housing (12), limiting tube (8) bring provided with at least one restraining portion provided with a cross section sized to limit the gas flow that flows from the inner cavity (6) to the bearing formation gap (7).

2. The flow restrictor of claim 1 characterized in that the restraining portion is positioned within the housing (12).

3. The flow restrictor of claim 1 or 2 characterized in that the cross section of the restraining portion is substantially circular, the substantially circular cross section having an inner diameter between 30 and 200 um.

4. The flow restrictor of any preceding claims, characterized in that the limiting tube (8) is substantially cylindrical.

5. The flow restrictor of any preceding claims characterized in that the limiting tube (8) has a substantially I-shaped profile.

6. The flow restrictor of any of claims 1 to 4 characterized in that the limiting tube (8) has a substantially L-shaped profile.

7. The flow restrictor of any of claims 1 to 4 characterized in that the limiting tube (8) extends radially from the housing (12) and is tangent to an outer wall of the cylinder (3).

8. The flow restrictor of any of claims 1 to 3 characterized in that the limiting tube (8) comprises one end portion (23) configured in a substantially conical shape, the end portion (23) being insertible in the housing (12).

9. The flow restrictor of any preceding claims characterized in that the limiting tube (8) is associated with the housing (12) by means of interference fit.

10. The flow restrictor of any preceding claims characterized in that the limiting tube (8) is fixed in the housing (12) by means of glue or soldering, the glue or soldering being capable of filling a space between the limiting tube (8) and the housing (12).

11. The flow restrictor of claim 1 characterized in that the limiting tube (8) is associated with the housing (12) by means of a connector (9) having a substantially L-shaped profile, where a first end of the connector (9) is associated with the housing (12), and, a second end of the connector (9) is associated with the limiting tube (8).

12. The flow restrictor of any preceding claims characterized in that it comprises at least one sealing ring (10) disposed within the housing (12), the sealing ring (10) radially surrounding at least a portion of the limiting tube (8).

13. The flow restrictor of any preceding claims, characterized in that it comprises a sealing bush (11) disposed within the housing (12), the sealing bush (11) longitudinally surrounding the limiting tube (8).

14. The flow restrictor of claim 13 characterized in that the sealing bush (11) is substantially conical.

15. The flow restrictor of any preceding claims characterized in that the housing (12) is substantially cylindrical.

16. The flow restrictor of any of claims 1 to 14 characterized in that the housing (12) is substantially conical.

17. The flow restrictor of any of claims 1 to 14 characterized in that the housing (12) has a chamfered end facing the inner cavity.

18. A flow restrictor for use in aerostatic bearing formation between a piston (2) and a cylinder (3) of a gas compressor, the gas compressor comprising at least:
a protective pad (5) that externally surrounds the cylinder (3);
an inner cavity (6) disposed between the protective pad (5) and the cylinder (3), the inner cavity (6) being fluidly fed by a discharge flow from a compression movement exerted by the piston (2) within the cylinder (3);
a bearing formation gap (7) that separates an outer wall of the piston (2) and an inner wall of the cylinder (3); and
a flow restrictor (1) provided with a housing (12) that fluidly associates the inner cavity (6) to the bearing formation gap (7),
the flow restrictor (1) being characterized in that it comprises at least one limiting tube (8) associated with the housing (12), the limiting tube (8) being provided with at least one restraining portion provided with a cross section having a pre-established area, the limiting tube (8) having a preestablished length, where the relationship between the cross section area of the restraining portion and the length of the limiting tube (8) is configured to limit the gas flow that optimally flows from inner cavity (6) to the bearing formation gap (7).

19. A gas compressor (4) comprising at least:
a cylinder (3);
a piston (2) reciprocally moveable within the cylinder (3);
a protective pad (5) that externally surrounds the cylinder (3);
an inner cavity (6) disposed between the protective pad (5) and the cylinder (3), the inner cavity (6) being fluidly fed by a discharge flow from a compression movement exerted by the piston (2) within the cylinder (3);
a bearing formation gap (7) separating an outer wall of the piston (2) and an inner wall of the cylinder (3); and
a flow restrictor (1) provided with a housing (12) that fluidly associates the inner cavity (6) to the bearing formation gap (7),
the gas compressor (4) being characterized in that the flow restrictor (1) comprises at least one limiting tube (8) associated with housing (12), the limiting tube (8) being provided with at least one restraining portion provided with a cross section sized to limit the gas flow flowing from the inner cavity (6) to the bearing formation gap (7).
